(19) United States
(12) Patent Application Publication
(10) Pub. No.: US 2005/0125444 A1
(43) Pub. Date: Jun. 9, 2005

(54) Report composer

(76) Inventor: Armen Grigorian, Melbourne (AU)

Correspondence Address: STITES & HARBISON PLLC, 1199 NORTH FAIRFAX STREET, SUITE 900, ALEXANDRIA, VA, 22314, US

(21) Appl. No.: 10/725,927

(22) Filed: Dec. 3, 2003

(51) Int. Cl. G06F 17/00

(52) U.S. Cl. 707/104.1

(57) ABSTRACT

A system for composing a report, comprising: data processing means for receiving and processing data; data input means for use by a user to input data for transmission to said data processing means; a visual display for displaying data by said data processing means; wherein said data processing means is operable: 1) to display data indicative of a plurality of sets of data or databases; 2) to receive data from data input means indicative of a selection from said sets of data or databases; 3) to respond to the receipt of said selection from said sets of data or databases by immediately displaying data indicative of categories of data contained in said selection from said sets of data or databases; 4) to receive data from data input means indicative of a selection from said categories of said data; 5) to respond to the receipt of said selection from said categories by immediately displaying data indicative of said selection of categories in the form of at least one control screen having, for each of said categories, a position menu for controlling a position in said report to be occupied by said respective category of data and a sorting menu for controlling a sorting priority to be assigned to said respective category of data; wherein said system is thereby controllable by said user to generate a report on the basis of a respective setting assigned to each of said respective position and to each of said respective sorting menus by said user.

### FIELD OF THE INVENTION

The present invention relates to an apparatus for composing reports, of particular application as a graphical user interface for composing reports on a computer.

### BACKGROUND OF THE INVENTION

Existing software systems for preparing reports provide tools that allow a user to specify, from a particular database or data file, those columns or rows to be extracted for display and the order in which such columns or rows should then be displayed. Tools are typically also provided that allow the user to filter the displayed columns or rows according to some rule and to display each column or row in a specified order.

The principal shortcoming of existing systems, however, is that the resulting report must be output in essentially final form before it can be inspected to see if it is indeed adequate for the purpose for which the report was desired, that is, whether the information contained in the specified columns or rows reveals a sought or useful trend or pattern.

### SUMMARY OF THE INVENTION

The invention provides, therefore, a system for composing a report, comprising:
data processing means for receiving and processing data;
data input means for use by a user to input data for transmission to said data processing means;
a visual display for displaying data by said data processing means;
wherein said data processing means is operable:
1) to display data indicative of a plurality of sets of data or databases;
2) to receive data from data input means indicative of a selection from said sets of data or databases;
3) to respond to the receipt of said selection from said sets of data or databases by immediately displaying data indicative of categories of data contained in said selection from said sets of data or databases;
4) to receive data from data input means indicative of a selection from said categories of said data;
5) to respond to the receipt of said selection from said categories by immediately displaying data indicative of said selection of categories in the form of at least one control screen having, for each of said categories, a position menu for controlling a position in said report to be occupied by said respective category of data and a sorting menu for controlling a sorting priority to be assigned to said respective category of data;
wherein said system is thereby controllable by said user to generate a report on the basis of a respective setting assigned to each of said respective position and to each of said respective sorting menus by said user.

Preferably, for each of said categories, said position menu includes an option indicating the non-display of said respective category of data and said sorting menu includes an option indicating that sorting should not proceed on the basis of said respective category whether or not said respective category is to be displayed.

Preferably said control screen further includes, for each of said categories, a data processing menu for controlling a manner in which the content of a respective category of data should be processed (such as by averaging, totalling, extracting a maximum value, extracting a minimum value, etc).

The invention also provides a method for composing a report, comprising:
displaying data indicative of a plurality of sets of data or databases to a user using a visual display by means of a computer;
inputting data to said computer indicative of a selection from said sets of data or databases;
immediately displaying on said display data indicative of categories of data contained in said selection from said sets of data or databases by means of said computer;
making a selection from said categories of said data and inputting to said computer data indicative of said selection;
immediately displaying on said display data indicative of said selection of categories in the form of at least one control screen having, for each of said categories, a position menu for controlling a position in said report to be occupied by said respective category of data and a sorting menu for controlling a sorting priority to be assigned to said respective category of data; and
controlling said computer by means of said control screen to generate a report on the basis of a respective setting assigned to each of said respective position and to each of said respective sorting menus by said user.

### BRIEF DESCRIPTION OF THE DRAWING

In order that the invention may be more clearly ascertained, an embodiment will now be described, by way of example, with reference to the accompanying drawings, in which:

FIG. 1 is a schematic view of a report composing system according to an embodiment of the present invention;

FIG. 2 is a schematic view of a display generated by the system of FIG. 1 for composing a report;

FIG. 3 is a schematic view of a display generated by the system of FIG. 1 with a first set of exemplary settings;

FIG. 4 is a schematic view of a display generated by the system of FIG. 1 with a second set of exemplary settings;

FIG. 5 is a schematic view of a display generated by the system of FIG. 1 with a third set of exemplary settings;

FIG. 6 is a schematic view of a display generated by the system of FIG. 1 with a fourth set of exemplary settings;

FIG. 7 is a schematic view of a display generated by the system of FIG. 1 with a fifth set of exemplary settings;

FIG. 8 is a schematic view of a display generated by the system of FIG. 1 with a sixth set of exemplary settings;

FIG. 9 is a schematic view of a display generated by the system of FIG. 1 with a seventh set of exemplary settings;

FIG. 10 is a schematic view of a display generated by the system of FIG. 1 with an eighth set of exemplary settings;

FIG. 11 is a schematic view of a display generated by the system of FIG. 1 with a ninth set of exemplary settings;

FIG. 12 is a schematic view of a display generated by the system of FIG. 1 with a tenth set of exemplary settings;

FIG. 13 is a schematic view of a display generated by the system of FIG. 1 with an eleventh set of exemplary settings;

FIG. 14 is a schematic view of a display generated by the system of FIG. 1 with a twelve set of exemplary settings;

FIG. 15 is a schematic view of a display generated by the system of FIG. 1 with a thirteenth set of exemplary settings;

FIG. 16 is a schematic view of a display generated by the system of FIG. 1 with a fourteenth set of exemplary settings;

FIG. 17 is a schematic view of a display generated by the system of FIG. 1 with a fifteenth set of exemplary settings;

FIG. 18 is a schematic view of a display generated by the system of FIG. 1 with a sixteenth set of exemplary settings;

FIG. 19 is a schematic view of a display generated by the system of FIG. 1 with a seventeenth set of exemplary settings;

FIG. 20 is a schematic view of a display generated by the system of FIG. 1 with an eighteenth set of exemplary settings;

FIG. 21 is a schematic view of a display generated by the system of FIG. 1 with a nineteenth set of exemplary settings;

FIG. 22 is a schematic view of a display generated by the system of FIG. 1 with a twentieth set of exemplary settings; and

FIG. 23 is a schematic view of a display generated by the system of FIG. 1 with a twenty-first set of exemplary settings.

### DETAILED DESCRIPTION

A report composing system according to an embodiment of the present invention is shown generally at 10 in FIG. 1, networked—along with other computers 12a, 12b—to a central server computer 14.

System 10 includes a user computer 16 with associated monitor 18, keyboard 20 and mouse 22. By means of keyboard 20 and mouse 22, a user can input data and control commands into user computer 16, and receive from user computer 16 output on monitor 18.

The system 10 includes program loaded on user computer 16 that, when executed by a user, provides a graphical display on monitor 18. The user can interact with that program by using keyboard 20 and mouse 22 and thereby compose a report.

As mentioned above, the program generates on monitor 18 a graphical display. Broadly speaking, the program generates displays that allow a user to view data stored on one or more computers (such as user computer 18 and networked computers 12a, 12b), to make a selection from that data, and to manipulate the selected data (including performing what are sometimes referred to as “slice and dice”, “drilling down” and “Trend Analysis” operations). Consequently, the user can use the system 10 to design or compose a report format, and subsequently a resulting report, that extracts useful information from the data.

In the following description, it should be understood that references to system 10 and to the aforementioned program loaded on user computer 12 are essentially interchangeable, as a user controls that software program by controlling the system 10 (by means of keyboard 20 and mouse 22).

Firstly, the program includes routines for presenting the user with a list of available data or databases, and prompts the user to make a selection therefrom. An example of such a list of shown in Table 1:

TABLE 1
Exemplary list of available databases

DATABASES
SQL Server CRM
DB2 -Sales
Oracle Purchases
. . .

The user selects one or more of these databases, and the program responds by accessing the selected database or databases, determines their contents, and presents to the user a list of available tables contained in the selected database or databases. An example of such a list of tables is shown in Table 2:

TABLE 2
Exemplary list of available tables

TABLES
SQL Server CRM
tblCompanyDetails
tblCompanyContacts
tblAppointments
tblHoursWorked
tblProjectDetails
. . .

The user is then prompted to select one or more tables and, in response to the making of that selection, the program displays the available columns in the selected table or tables. An example of such a list of columns is shown in Table 3:

TABLE 3
Exemplary list of available columns

COLUMNS
tblProjectDetails
ProjectID
ClientID
Department
Hours
Period
Revenue
. . .

The user then selected the desired columns of interest. The program represents each selected column as a selection frame, and classes each selected column into a respective reporting type that is given a heading name and a sequence number for the subsequent composer view. The user also specifies a position for each frame, indicative of the position in the ultimate report in which the corresponding column may appear. An example of the resulting display is shown in Table 4:

TABLE 4
Exemplary display of selection frames

| FRAMES | | | | | |
|---|---|---|---|---|---|
| Name | Position | Heading | Type | | Format |
| ProjectID | 2 | Project | S | Look-Up | |
| ClientID | 1 | Client | S | Look-Up | |
| Department | 3 | Department | D | Drop-Down | |
| Hours | 4 | Working hours | O | Display Only | “00:00” |

The program then presents to the user on monitor 18 with a display containing all possible fields for the given view in the specified order. In this embodiment, therefore, the user is presented with a screen with from 1 to 25 frames. Each frame corresponds to a column of the ultimate report, that column having a caption identical to the frame.

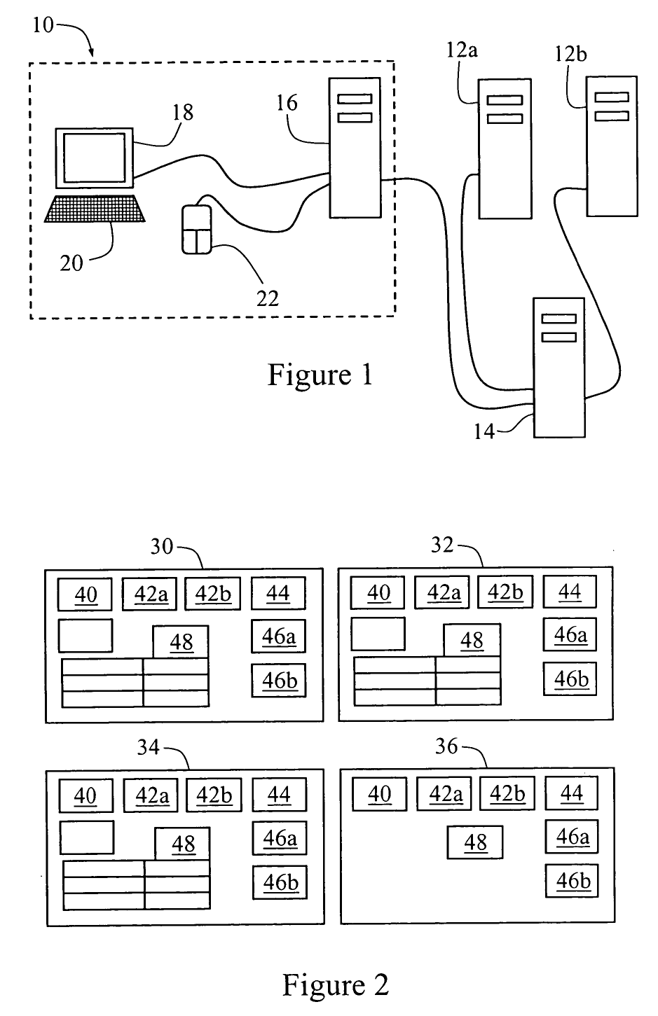

In the above example, therefore, the ClientID Frame will be the first frame, followed by the ProjectID Frame, the Department Frame, and the Hours Frame. This is illustrated schematically in FIG. 2.

The report composer routine of the program then uses one of the templates created above to produce the output as defined by the user. The screen is colour-coded to aid user recognition and therefore make the forming of selections quicker.

The user can produce a large number of possible report formats by:

1) Choosing the fields to be included in the report and nominating their order. Thus, referring to FIG. 2, in this example four frames (and therefore possible selections) Client Frame 30, Project Frame 32, Department Frame 34 and Hours Frame 36 are available, but for the particular report the user may require only two. The user therefore uses drop-down menu 40. Drop-down menu 40 has, in this example, options 0 to 4 owing to there being four frames and hence four possible position in any ultimate report for the respective frame (when displayed as a column). Thus, if the user selects “2” from drop-down menu 40, that frame will be displayed in the ultimate report as column no. 2. Selecting “0” means “no display”. Importantly, a frame can be used in the calculation of a summary report (discussed below) or for dictating the sorting of another frame and hence column (also discussed below) even though that frame has drop-down menu 40 set to “zero”. Thus, the content and appearance of the ultimate report can be controlled on the basis of data not actually contained in that report.

2) Nominating the sorting order of the fields on the report. It is possible to specify order number (that is, the ordinal position a respective frame will occupy in the sorting of the report) and order type (ascending or descending) by means of drop-down menus 42a, 42b respectively. For example, if the drop-down menu 42a of a frame is set to “1”, the ultimate report will be ordered firstly on the basis of that frame. The frame where this drop-down menu 42a is set to “2” will dictate the next level of sorting (where, for example, two rows have the same first level sorting entry), and so on. Drop-down menu 42b is used to control whether the sorting according to that frame should be ascending or descending.

3) The user may choose to create a summary report. The user selects from several possible summary types: “group by” (G), the sum of all values (Σ), the number of values (N), the average value (A), the minimum value (m) or the maximum value (M). Whether a summary report is desired, and the type of summary report if desired, are indicated by means of drop-down menu 44.

4) Choosing the fields to be included in heading or detail. This selection is made by means of drop-down menus 46a, 46b. This is specified by the row on the report and heading represented by Subtotal.

5) Include and exclude selected values. These values can be typed, looked-up, selected from a drop-down menu, or selected by means of selectable yes/no values; this is specified by means of drop-down menu 48. This provides the opportunity for comparison of the data or for creating a summary of the different values.

After all selections are made, the user clicks a “Run” button (not shown). The resulting selection is then displayed on a new screen and can be output in EXCEL (TM) brand format, which assists further formatting; the output can also be saved or e-mailed.

Examples of the possible report formats and therefore reports that can be created by the system 10 following the above procedure are described below. In each case, a figure is presented showing the drop-down menu selections employed to create the required report. In those figures, the drop-down and other menu settings shown have the following meanings:
G: prepare “group by” summary report;
Σ: prepare a “sum of all values” summary report;
N: prepare a “number of values summary report;
A: prepare an “average value summary report;
m: prepare a “minimum value summary report;
M: prepare a “maximum value summary report;
S: look-up a value;
D: drop-down menu; and
O: display only.

In these examples, the above example of selected frames shown in Table 4 is used, in which the frames are displayed in the order specified in that table: ClientID, ProjectID, Department and Hours. In each case, drop-down menu 48 is set as follows: there is a look-up “S” available for ProjectID and for ClientID selection and a drop-down menu “D” for the Department. There is no selection in the Hours frame (hence “O”: display only).

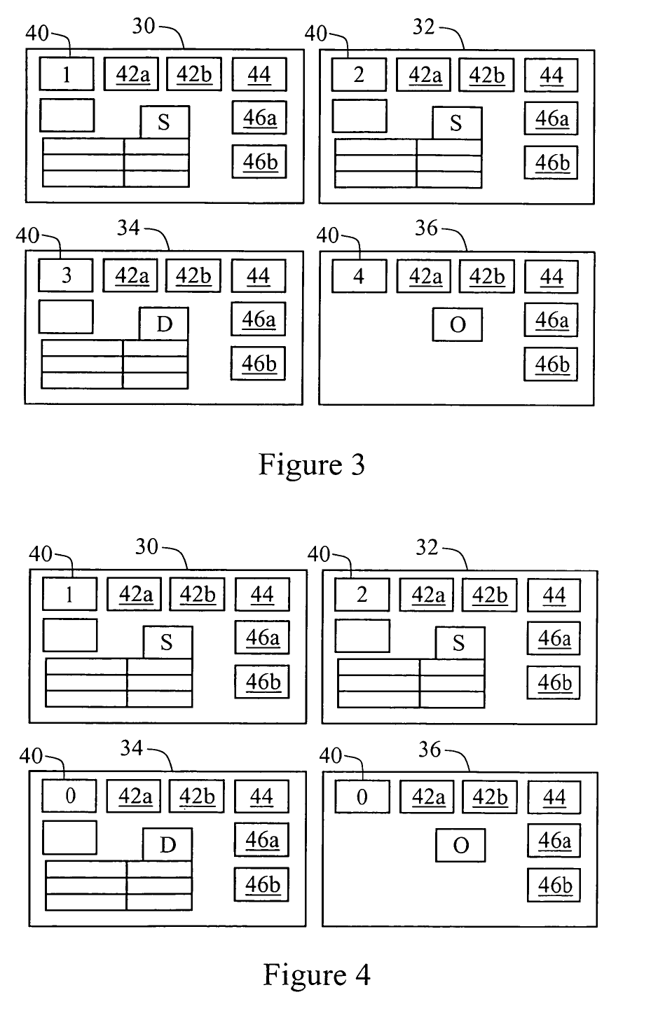

i) Thus, if the user wishes to compose a report with a list of Clients, Projects, Departments and Hours in that order, since these frames already have the desired that are simply numbered (by means of drop-down menus 40) “1”, “2”, “3” and “4” respectively (see FIG. 3). The resulting, notional output is shown in Table 5.

TABLE 5
Clients, Projects, Departments and Hours

| CLIENT | PROJECT | DEPARTMENT | HOURS |
|---|---|---|---|
| Alexander Services | Alexander Company | Green | 200 |
| | Analysis | | |
| Alexander Services | Alexander 2nd Audit | Green | 300 |
| Radical Retailing | Radical HR Policy | Briggs | 260 |
| Radical Retailing | Radical HR Policy | Briggs | 800 |
| Radical Retailing | Radical HR Policy | Briggs | 600 |
| Alexander Services | Alexander Company | Green | 800 |
| | Analysis | | |
| BON Corporation | BON Company | Black | 500 |
| | Analysis | | |
| Creative Consulting | Creative Company | Thompson | 100 |
| | manual | | |

ii) If, from Clients, Projects, Departments and Hours, the user only wishes the report to include a list of Clients and Projects, the user sets drop-down menus 40 to “1”, “2”, “0” and “0” respectively (see FIG. 4); the resulting output is shown in Table 6.

TABLE 6
Clients and Projects

| CLIENT | PROJECT |
|---|---|
| Alexander Services | Alexander Company Analysis |
| Alexander Services | Alexander 2nd Audit |
| Radical Retailing | Radical HR Policy |
| Radical Retailing | Radical HR Policy |
| Radical Retailing | Radical HR Policy |
| Alexander Services | Alexander Company Analysis |
| BON Corporation | BON Company Analysis |
| Creative Consulting | Creative Company manual |

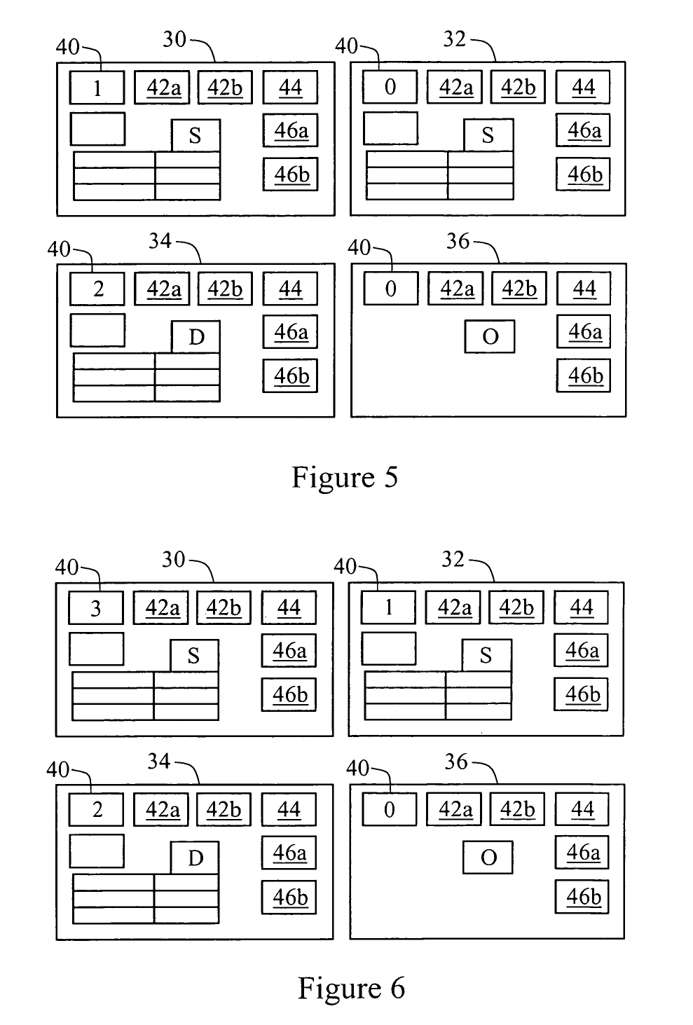

iii) The settings shown in FIG. 5 are used to generate a report comprising a list of Clients and Departments, with the resulting output shown in Table 7.

TABLE 7
Clients and Departments

| CLIENT | DEPARTMENT |
|---|---|
| Alexander Services | Green |
| Alexander Services | Green |
| Radical Retailing | Briggs |
| Radical Retailing | Briggs |
| Radical Retailing | Briggs |
| Alexander Services | Green |
| BON Corporation | Black |
| Creative Consulting | Thompson |

iv) The settings shown in FIG. 6 are used to generate a report comprising a list of Projects, Departments and Clients, with the resulting output shown in Table 8.

TABLE 8
Projects, Departments and Clients

| PROJECT | DEPARTMENT | CLIENT |
|---|---|---|
| Alexander Company Analysis | Green | Alexander Services |
| Alexander 2nd Audit | Green | Alexander Services |
| Radical HR Policy | Briggs | Radical Retailing |
| Radical HR Policy | Briggs | Radical Retailing |
| Radical HR Policy | Briggs | Radical Retailing |
| Alexander Company Analysis | Green | Alexander Services |
| BON Company Analysis | Black | BON Corporation |
| Creative Company manual | Thompson | Creative Consulting |

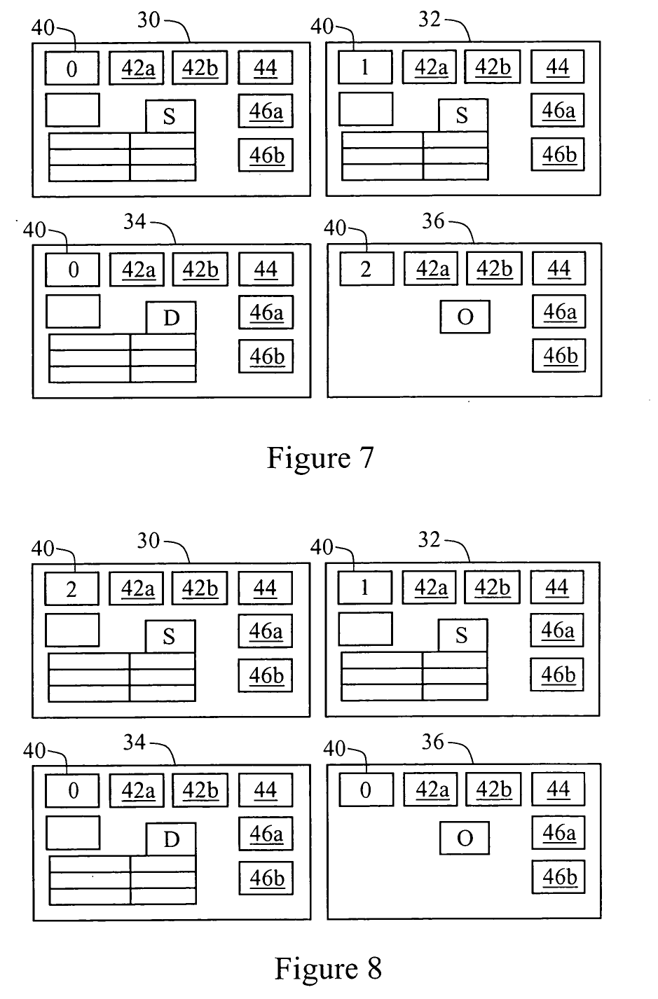

v) The settings shown in FIG. 7 are used to generate a report comprising a list of Projects and Hours, with the resulting output shown in Table 9.

TABLE 9
Projects and Hours

| PROJECT | HOURS |
|---|---|
| Alexander Company Analysis | 200 |
| Alexander 2nd Audit | 300 |
| Radical HR Policy | 260 |
| Radical HR Policy | 800 |
| Radical HR Policy | 600 |
| Alexander Company Analysis | 800 |
| BON Company Analysis | 500 |
| Creative Company manual | 100 |

vi) The settings shown in FIG. 8 are used to generate a report comprising a list of Projects and Clients, with the resulting output shown in Table 10.

TABLE 10
Projects and Clients

| PROJECT | CLIENT |
|---|---|
| Alexander Company Analysis | Alexander Services |
| Alexander 2nd Audit | Alexander Services |
| Radical HR Policy | Radical Retailing |
| Radical HR Policy | Radical Retailing |
| Radical HR Policy | Radical Retailing |
| Alexander Company Analysis | Alexander Services |
| BON Company Analysis | BON Corporation |
| Creative Company manual | Creative Consulting |

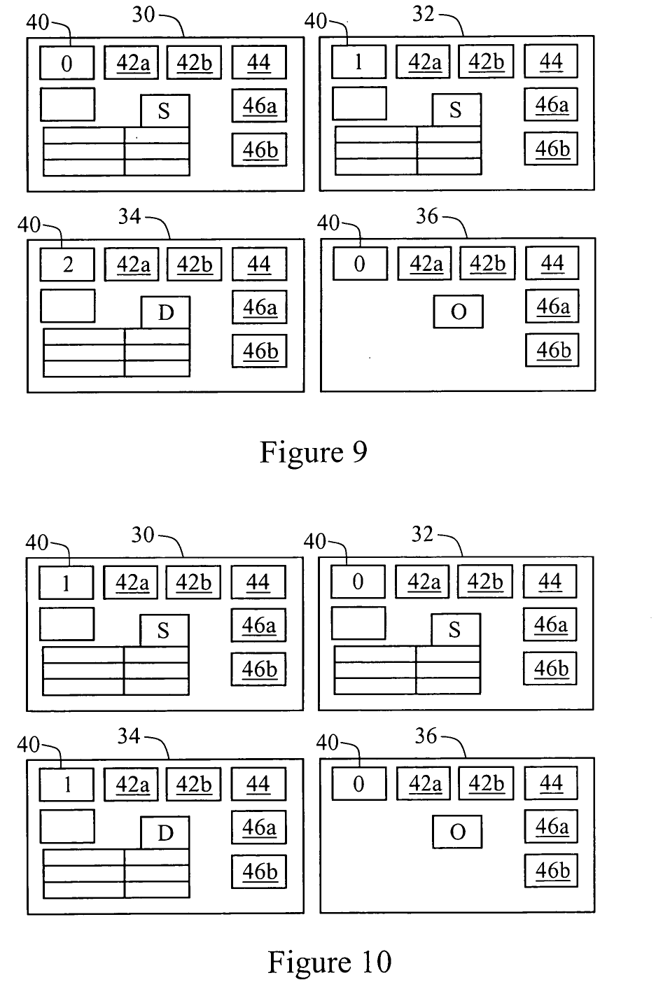

vii) The settings shown in FIG. 9 are used to generate a report comprising a list of Projects and Departments, with the resulting output shown in Table 11.

TABLE 11
Projects and Departments

| PROJECT | DEPARTMENT |
|---|---|
| Alexander Company Analysis | Green |
| Alexander 2nd Audit | Green |
| Radical HR Policy | Briggs |
| Radical HR Policy | Briggs |
| Radical HR Policy | Briggs |
| Alexander Company Analysis | Green |
| BON Company Analysis | Black |
| Creative Company manual | Thompson |

viii) The settings shown in FIG. 10 are used to generate a report comprising a list of Departments and Clients, with the resulting output shown in Table 12.

TABLE 12
Departments and Clients

| DEPARTMENT | CLIENT |
|---|---|
| Green | Alexander Services |
| Green | Alexander Services |
| Briggs | Radical Retailing |
| Briggs | Radical Retailing |
| Briggs | Radical Retailing |
| Green | Alexander Services |
| Black | BON Corporation |
| Thompson | Creative Consulting |

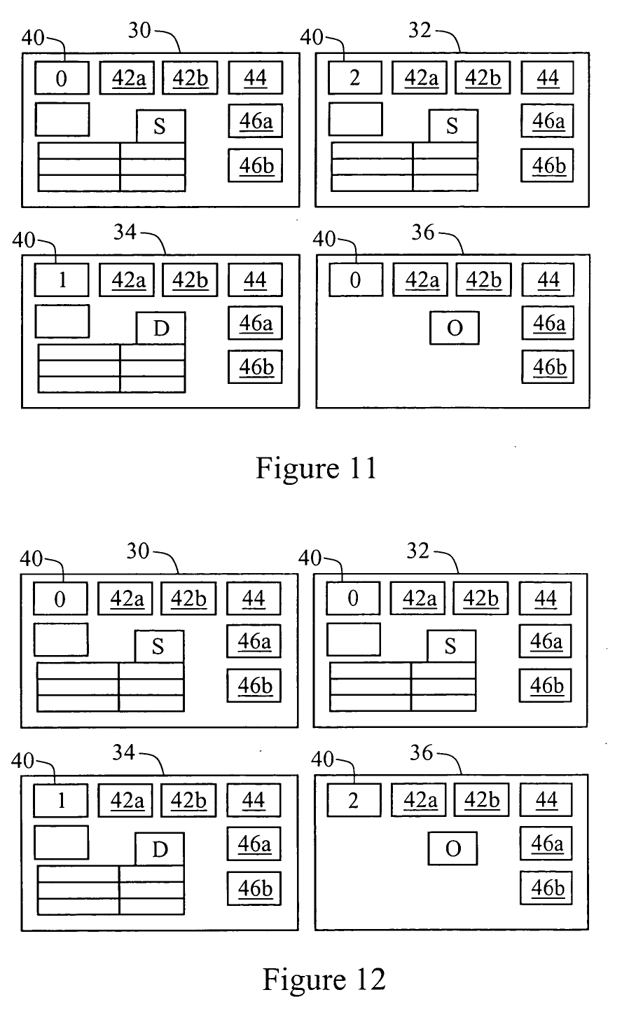

ix) The settings shown in FIG. 11 are used to generate a report comprising a list of Departments and Projects, with the resulting output shown in Table 13.

TABLE 13
Departments and Projects

| DEPARTMENT | PROJECT |
|---|---|
| Green | Alexander Company Analysis |
| Green | Alexander 2nd Audit |
| Briggs | Radical HR Policy |
| Briggs | Radical HR Policy |
| Briggs | Radical HR Policy |
| Green | Alexander Company Analysis |
| Black | BON Company Analysis |
| Thompson | Creative Company manual |

x) The settings shown in FIG. 12 are used to generate a report comprising a list of Departments and Hours, with the resulting output shown in Table 14.

TABLE 14
Departments and Hours

| DEPARTMENT | HOURS |
|---|---|
| Green | 200 |
| Green | 300 |
| Briggs | 260 |
| Briggs | 800 |
| Briggs | 600 |
| Green | 800 |
| Black | 500 |
| Thompson | 100 |

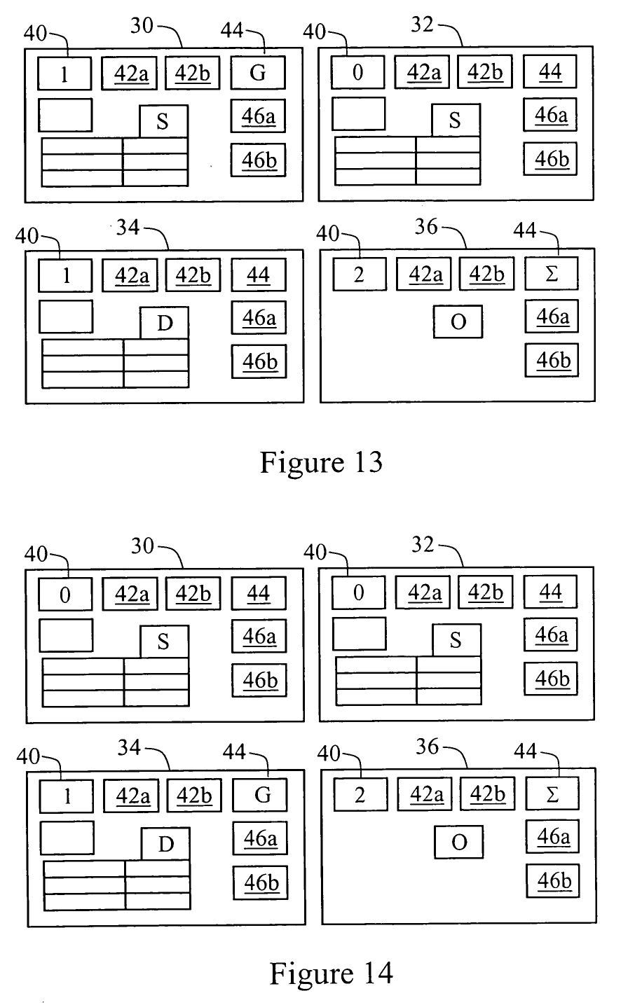

xi) The settings shown in FIG. 13 are used to generate a summary report comprising the Hours by Client (with Grand total or without), with the resulting output shown in Table 15.

TABLE 15
Hours by Client

| CLIENT | HOURS |
|---|---|
| Alexander Services | 1300 |
| Radical Retailing | 1660 |
| BON Corporation | 500 |
| Creative Consulting | 100 |

xii) The settings shown in FIG. 14 are used to generate a summary report comprising the Hours by Department (with Grand total or without), with the resulting output shown in Table 16.

TABLE 16
Hours by Department

| DEPARTMENT | HOURS |
|---|---|
| Green | 1300 |
| Briggs | 1660 |
| Black | 500 |
| Thompson | 100 |

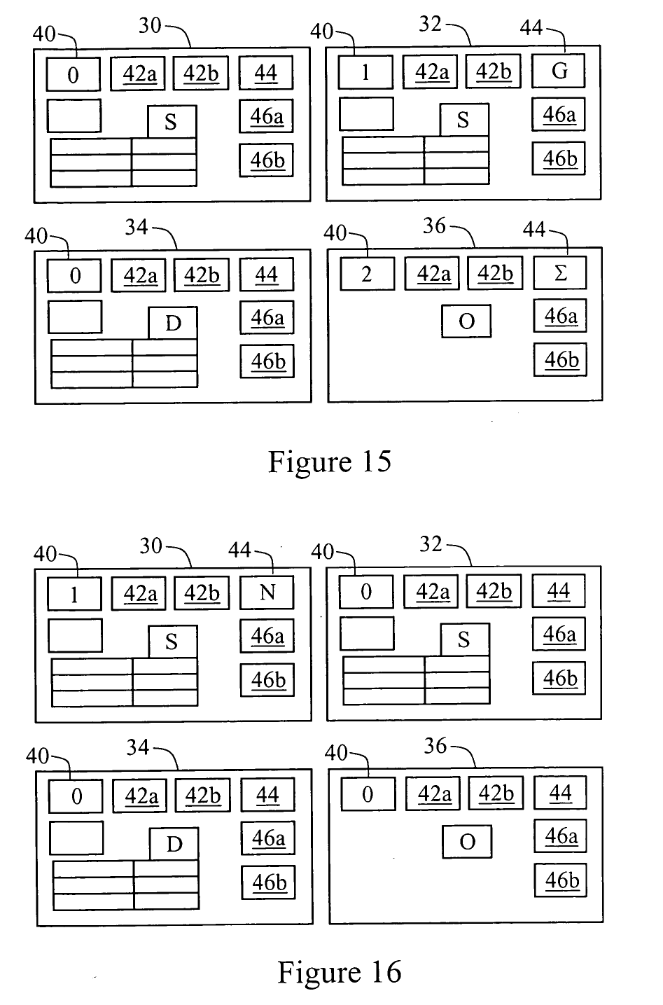

xiii) The settings shown in FIG. 15 are used to generate a summary report comprising the Hours by Project (with total or without), with the resulting output shown in Tables 17 and 18.

TABLE 17
Hours by Project (with total)

| PROJECT | HOURS |
|---|---|
| Alexander Company Analysis | 1000 |
| Alexander 2nd Audit | 300 |
| Radical HR Policy | 1660 |
| BON Company Analysis | 500 |
| Creative Company manual | 100 |
| | 3560 |

TABLE 18
Hours by Project (without total)

| PROJECT | HOURS |
|---|---|
| Alexander Company Analysis | 1000 |
| Alexander 2nd Audit | 300 |
| Radical HR Policy | 1660 |
| BON Company Analysis | 500 |
| Creative Company manual | 100 |

xiv) The settings shown in FIG. 16 are used to generate a summary report comprising the Number of Clients (with total or without), with the resulting output shown in Table 19.

TABLE 19
Number of Clients
CLIENT
4

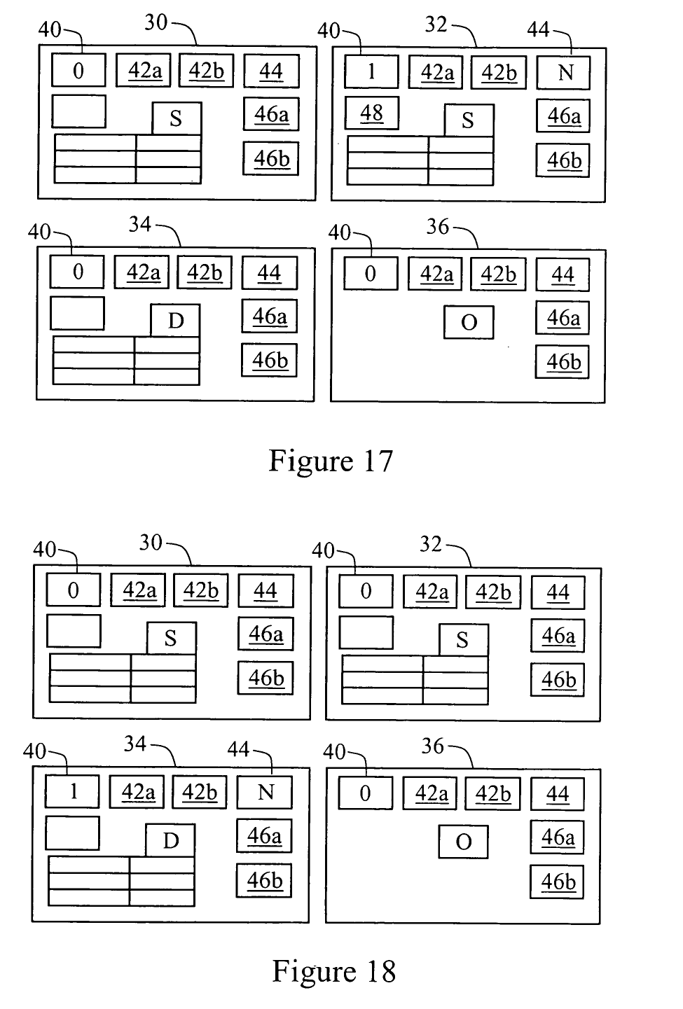

xv) The settings shown in FIG. 17 are used to generate a summary report comprising the Number of Projects (with total or without), with the resulting output shown in Table 20.

TABLE 20
Number of Projects
PROJECT
5

xvi) The settings shown in FIG. 18 are used to generate a summary report comprising the Number of Departments, with the resulting output shown in Table 21.

TABLE 21
Number of Departments
DEPARTMENT
4

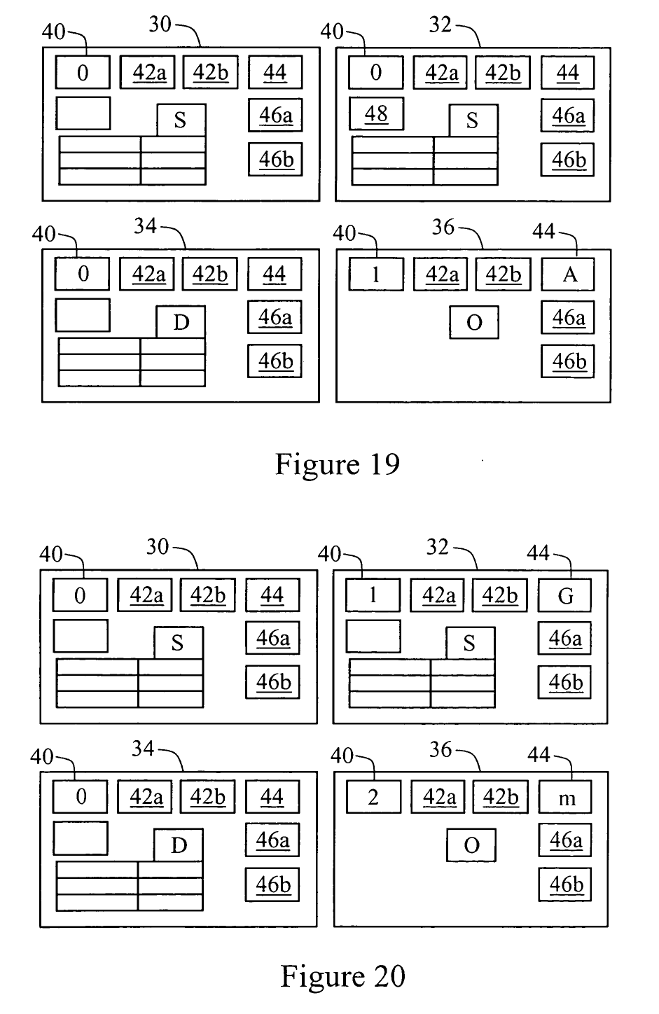

xvii) The settings shown in FIG. 19 are used to generate a summary report comprising the Average Hours, with the resulting output shown in Table 22.

TABLE 22
Average Hours
HOURS
890

xviii) The settings shown in FIG. 20 are used to generate a summary report comprising the minimum hours spend on a project, with the resulting output shown in Table 23.

TABLE 23
Minimum Hours Spend on a Project

| PROJECT | HOURS |
|---|---|
| Creative Company manual | 100 |

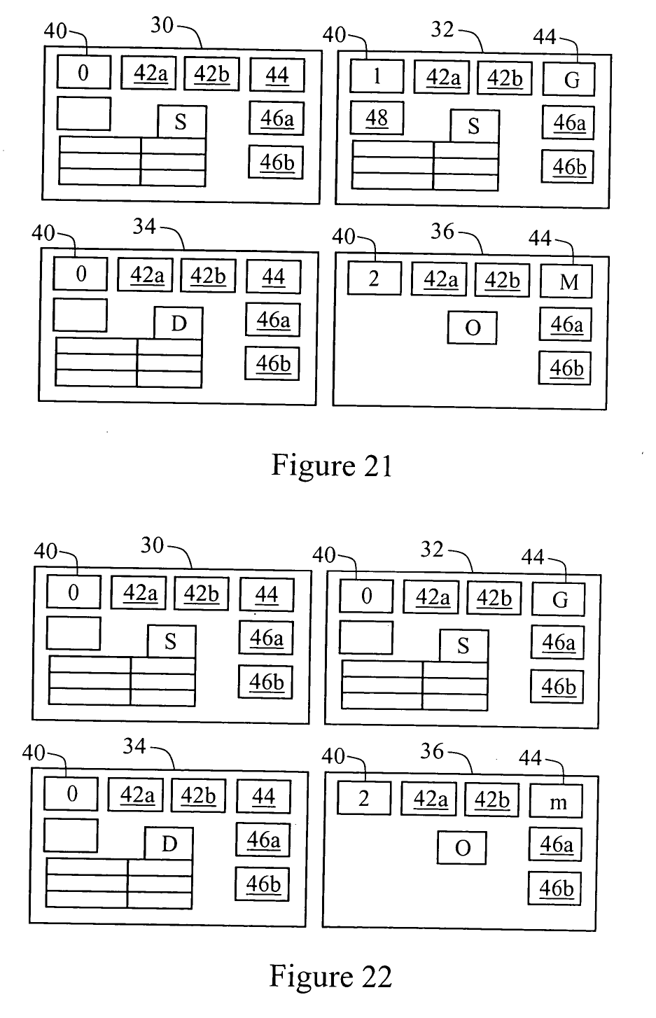

xix) The settings shown in FIG. 21 are used to generate a summary report comprising the maximum hours spend on a project, with the resulting output shown in Table 24.

TABLE 24
Maximum Hours Spend on a Project

| PROJECT | HOURS |
|---|---|
| Radical HR Policy | 1660 |

xx) The settings shown in FIG. 22 are used to generate a summary report comprising the minimum hours spend on a project, with the resulting output shown in Table 25. In this example, whose output is otherwise comparable to that shown in Table 23, the name of the project is not included in the output—even though the summary report concerns the projects—because drop-down menu 40 of Project Frame 32 has been set to “0”.

TABLE 25
Minimum Hours Spend On a Project
HOURS
100

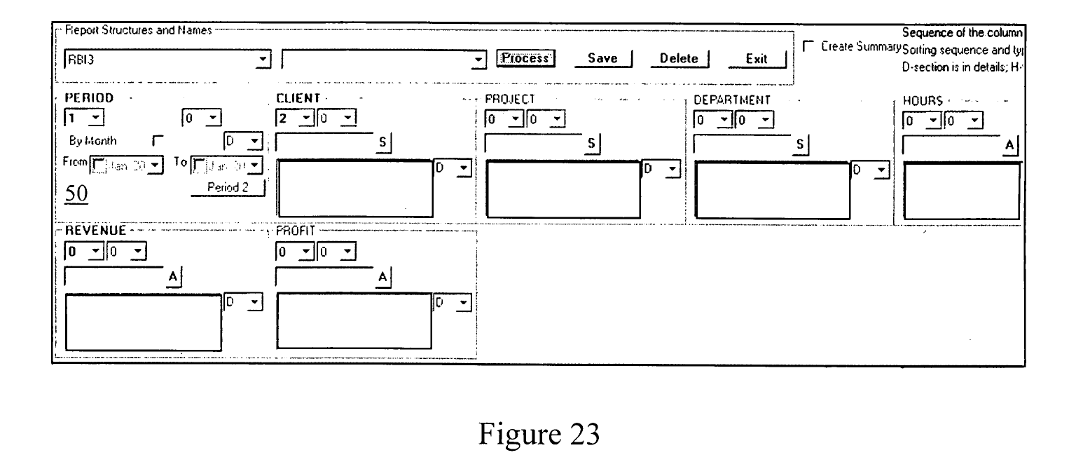

xxi) FIG. 23 is a screen grab of a display generated by a system according to an embodiment of the present invention, and is comparable to the schematic views shown in FIG. 2 to 22. Unlike the examples shown in FIG. 2 to 22, however, a further frame corresponding to time Period has been included so that the data can also be sorted by date. The Period Frame 50 includes two drop-down menus by means of which a user can specify the start and end of a date range. Thus, in the example shown in FIG. 23, the user has selected—from Period, Clients, Projects, Departments and Hours—only Period and Clients. Consequently, the user has set drop-down menus 40 to “1”, “2”, “0”, “0” and “0” respectively.

Thus, from this single data structure, the user can generate 60 or more views based on the same information. “Slicing and dicing” the data in different ways allows you to establish trends in your business, and to do so on the fly.

The system 10 thus constitutes a roles based viewer to allow a person to view multiple fields from multiple databases providing the specific information they require to perform their duties, and a portal based business intelligence viewer which can be implemented over a network (such as the internet or an intranet), with real-time analytical processing and hence ad hoc intelligence querying functionality.

Modifications within the scope of the invention may be readily effected by those skilled in the art. It is to be understood, therefore, that this invention is not limited to the particular embodiments described by way of example hereinabove.

Further, any reference herein to prior art is not intended to imply that such prior art forms or formed a part of the common general knowledge.

1. A system for composing a report, comprising:
data processing means for receiving and processing data;
data input means for use by a user to input data for transmission to said data processing means;
a visual display for displaying data by said data processing means;
wherein said data processing means is operable:
1) to display data indicative of a plurality of sets of data or databases;
2) to receive data from data input means indicative of a selection from said sets of data or databases;
3) to respond to the receipt of said selection from said sets of data or databases by immediately displaying data indicative of categories of data contained in said selection from said sets of data or databases;
4) to receive data from data input means indicative of a selection from said categories of said data;
5) to respond to the receipt of said selection from said categories by immediately displaying data indicative of said selection of categories in the form of at least one control screen having, for each of said categories, a position menu for controlling a position in said report to be occupied by said respective category of data and a sorting menu for controlling a sorting priority to be assigned to said respective category of data;
wherein said system is thereby controllable by said user to generate a report on the basis of a respective setting assigned to each of said respective position and to each of said respective sorting menus by said user.

2. A system as claimed in claim 1, wherein, for each of said categories, said position menu includes an option indicating the non-display of said respective category of data and said sorting menu includes an option indicating that sorting should not proceed on the basis of said respective category whether or not said respective category is to be displayed.

3. A system as claimed in claim 1, wherein said control screen further includes, for each of said categories, a data processing menu for controlling a manner in which the content of a respective category of data should be processed.

4. A system as claimed in claim 3, wherein said data processing menu includes one or more options selected from the group comprising: averaging, totalling, extracting a maximum value, and extracting a minimum value.

5. A method for composing a report, comprising:
displaying data indicative of a plurality of sets of data or databases to a user using a visual display by means of a computer;
inputting data to said computer indicative of a selection from said sets of data or databases;
immediately displaying on said display data indicative of categories of data contained in said selection from said sets of data or databases by means of said computer;
making a selection from said categories of said data and inputting to said computer data indicative of said selection;
immediately displaying on said display data indicative of said selection of categories in the form of at least one control screen having, for each of said categories, a position menu for controlling a position in said report to be occupied by said respective category of data and a sorting menu for controlling a sorting priority to be assigned to said respective category of data; and
controlling said computer by means of said control screen to generate a report on the basis of a respective setting assigned to each of said respective position and to each of said respective sorting menus by said user.

6. A computer program product directly loadable into the internal memory of a computer, comprising software code portions for performing the steps of the method for composing a report as claimed in claim 5 when said product is run on a computer.

7. A computer program product stored on a computer useable medium, comprising computer readable program means for causing a computer to perform the steps of the method for composing a report as claimed in claim 5.

8. A computer readable medium, having a program recorded thereon, wherein said program is for making a computer execute the method for composing a report as claimed in claim 5.
